(19) United States
(12) Patent Application Publication
(10) Pub. No.: US 2008/0110900 A1
(43) Pub. Date: May 15, 2008

(54) CONTAINER FOR FLUIDS, IN PARTICULAR LIQUIDS, AND A METHOD OF MAKING A CONTAINER

(75) Inventor: Jan Veenendaal, Den Helder (NL)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Eurokeg B.V., Den Helder (NL)

(21) Appl. No.: 11/679,583

(22) Filed: Feb. 27, 2007

Related U.S. Application Data
(63) Continuation-in-part of application No. 11/559,208, filed on Nov. 13, 2006.

(51) Int. Cl. B31B 1/84; B67D 5/64; B65D 88/12

(52) U.S. Cl. 220/564; 493/87

(57) ABSTRACT

A container for fluids, in particular liquids, such as beer or water, includes a spherical or spheroid casing, a valve part for filling the container with a fluid and an outer package surrounding the casing. The outer package comprises a shell, which follows the circumference of the casing.

### CROSS-REFERENCE TO RELATED APPLICATION

The present application is a continuation-in-part of and claims priority of U.S. patent application Ser. No. 11/559,208, filed Nov. 13, 2006, the content of which is hereby incorporated by reference in its entirety.

### BACKGROUND

The discussion below is merely provided for general background information and is not intended to be used as an aid in determining the scope of the claimed subject matter.

The invention relates to a container for fluids, in particular but not limited to liquids, such as beer or water, comprising a casing, preferably a pressure resistant casing, and a valve part for filling the container with a fluid. The invention further relates to a blank for folding an outer package around a spherical or spheroid casing and a method of making a container.

EP 862 535 discloses a container for fluids comprising an outer and preferably ellipsoid casing of a flexible, pressure resistant material, a gastight inner casing of flexible material located inside the outer casing, and a filling connection for filling the inner casing. As a result, the container is collapsible so that filling the container may take place from the collapsed condition and filling is therefore possible without pressure difference while the fluid does not enter an empty space. The egress of gas from the fluid is substantially reduced.

In practice, some embodiments according to EP 862 535, such as the BB/30 disposable beer container by EML Productie of The Netherlands, have been provided with an outer package, viz. a cardboard box.

### SUMMARY

This Summary and the Abstract are provided to introduce some concepts in a simplified form that are further described below in the Detailed Description. The Summary and Abstract are not intended to identify key features or essential features of the claimed subject matter, nor is it intended to be used as an aid in determining the scope of the claimed subject matter. In addition, the description herein provided and the claimed subject matter should not be interpreted as being directed to addressing any of the short-comings discussed in the Background.

A container according to the opening paragraph comprises a spherical or spheroid casing and an outer package surrounding the casing, wherein the outer package comprises a shell, which follows the circumference of the casing.

In one embodiment, the shell is cylindrical and has a circular cross-section or a polygonal cross-section with at least five angles. In a further embodiment, at least one of the ends of the cylindrical shell is open and that the valve part is accessible through this open end.

Also, the shell can comprise a plurality of grips, e.g. openings for accommodating a hand, such that, when the container is lifted by means of these grips, the valve part will normally face upwards.

The outer package significantly improves handling and provides effective protection of the spherical or spheroid casing with a relatively small amount of material, especially when compared to a box. Further, the package allows the container to be stored and stacked in an upright position and provides an appearance that resembles an ordinary keg.

To secure the container inside the outer package, the shell can include, on its inner wall and at or near its (upper) rim nearest the valve part and/or at or near its (bottom) rim remote from the valve part, means for retaining the casing inside the shell, for example a plurality of inwardly extending lamellae providing a one way retaining means, as will be explained in more detail below.

Another aspect of the invention relates to a blank for folding an outer package around a spherical or spheroid casing, which blank is substantially oblong in shape and which comprises a plurality of fold lines, extending substantially parallel to the short sides of the blank, and, at or near at least one, and in one embodiment both, of the long sides and on the fold lines, a plurality of cuts or slots.

The invention also relates to a blank for folding an outer package around a spherical or spheroid casing, which blank is substantially oblong in shape and which comprises a plurality of fold lines, extending substantially parallel to the short sides of the blank, and, at or near at least one, preferably both, of the long sides and on or in line with the fold lines, a plurality of cuts, slots or further fold lines, which can be V-shaped cuts, slots or fold lines.

Another aspect of the invention relates to a container for fluids comprising an outer casing, a gas and/or fluid tight inner casing of a flexible material located inside the outer casing, and a valve part for filling the container with a fluid, wherein the inner casing comprises at least one polygonal sheet of a flexible material, and in one embodiment two polygonal sheets of a flexible material sealed together along their edges.

Another aspect of the invention relates to a method of making a container for fluids, comprising a casing having an opening and a valve part attached to the opening, which method includes melting a polymeric material, forming the casing from the material, for example by means of blow-molding, and attaching the valve part to the casing while the casing is still sufficiently hot for it to be plastically deformed, i.e. preferably before it has cooled down to a temperature below 40° C., more preferably before it has cooled down to a temperature below 50° C.

In one embodiment, the valve part comprises a threaded portion, that the casing is formed in a mold comprising a feature corresponding to that threaded portion, such that the molded casing includes a threaded opening for receiving the threaded portion of the valve part, and that the valve part is screwed to the inner casing.

In one embodiment, it is preferred that the valve part is still sufficiently hot or, in the alternative, heated to a temperature sufficiently high for it to be plastically deformed, i.e. the valve part preferably has a temperature equal to or above 40° C., more preferably equal to or above 50° C.

In a further embodiment, the valve part comprises a threaded portion or a snap-fit element (for example, a so-called angular snap-fit element, such as a rib or notch spanning the circumference of valve part), that the casing is formed in a mold comprising a feature corresponding to that threaded portion or snap-fit element (for example, a notch or rib, respectively), such that the molded casing comprises a threaded opening or an opening comprising a snap-fit counter element for receiving the threaded portion or the snap-fit element of the valve part, and that the valve part is screwed to respectively snap-fitted onto the inner casing.

The method was found to be surprisingly effective in providing a tight fit between the valve part and the casing. Additional tooling, i.e. milling of the upper rim of the opening in the casing to improve the fluid-tightness of the connection, is no longer required. Moreover, depending on the exact configuration of the container, the present method may also obviate the need for a seal or gasket between the valve part and the casing.

Within the framework of the present invention the term “spheroid” is defined as any shape generated by a half-revolution of a square or rectangle with rounded corners or an ellipse or oval about its major axis or minor axis.

### BRIEF DESCRIPTION OF THE DRAWINGS

Aspects of the invention will now be explained in more detail with reference to the drawings, which show an embodiment of the present invention.

FIG. 1 is a perspective view of a prior art container, with part of the outer and inner casings cutaway.

FIGS. 2A to 2C are perspective views of a container enveloped by a first example of a cardboard shell.

FIG. 2D is a perspective view of a container enveloped by a second example of a cardboard shell.

FIG. 3 is a top plan view of a blank suitable for forming a shell as shown in FIGS. 2A to 2C.

FIG. 4 is a top view of an empty inner casing for use in the present container.

### DETAILED DESCRIPTION

The drawings are not necessarily to scale and details, which are not necessary for understanding aspects of the present invention, may have been omitted. Further, elements that are at least substantially identical or that perform an at least substantially identical function are denoted by the same numeral.

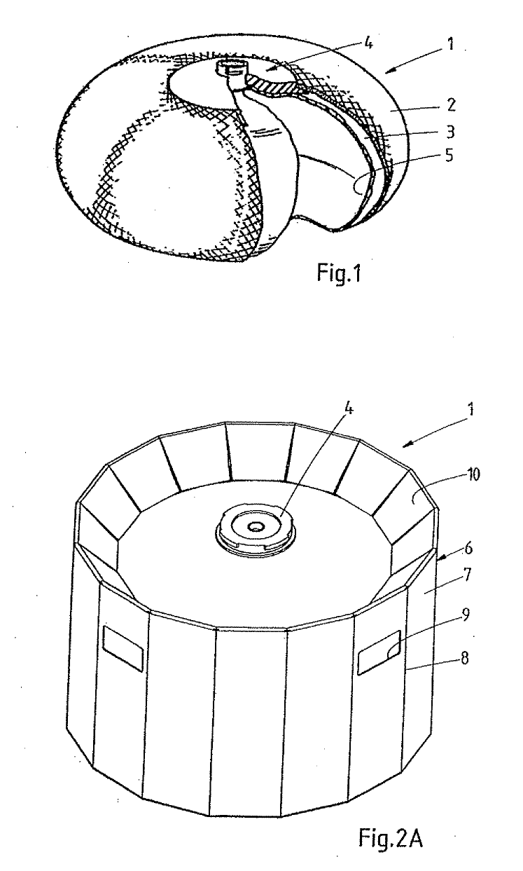

FIG. 1 shows a container 1 for fluids, in particular liquids, such as beer under pressure or water, comprising a spheroid and pressure resistant outer casing 2, a gastight inner casing 3 of a flexible material, i.e. a bag, located inside the outer casing 2, and a valve part 4 for filling the container with a fluid respectively tapping fluid from the container.

In this example, the outer casing 2 is collapsible and made from a blow-molded thermoplastic e.g. PE (polyethylene) or elastomeric liner provided with a filament wound outer reinforcement and an outer layer of latex obtained by immersing the liner (with filaments) in a latex bath. In an alternative example, the liner is rigid and made of e.g. a relatively thick-walled thermoplastic material or even a metal, such as aluminum. Yet other suitable casings are described in, for example, European patent application EP 0 626 338, which is incorporated herein by reference.

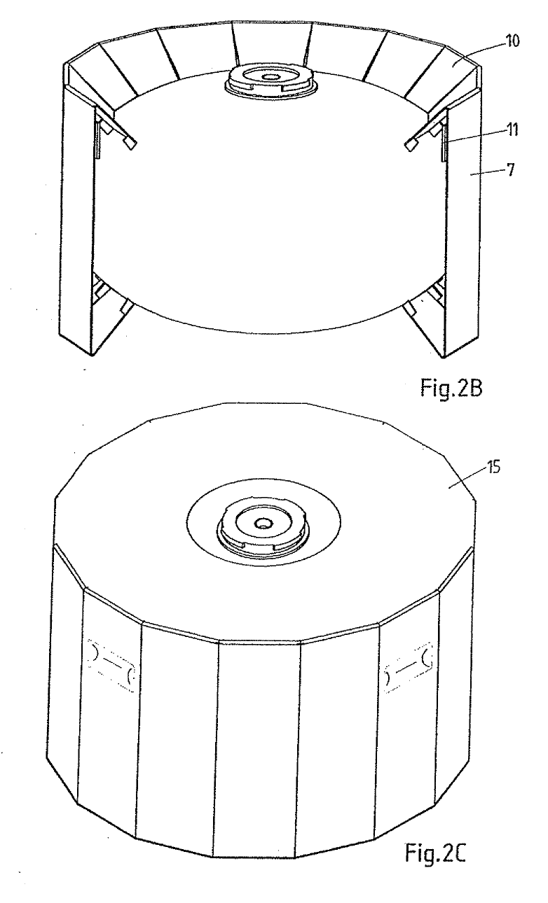

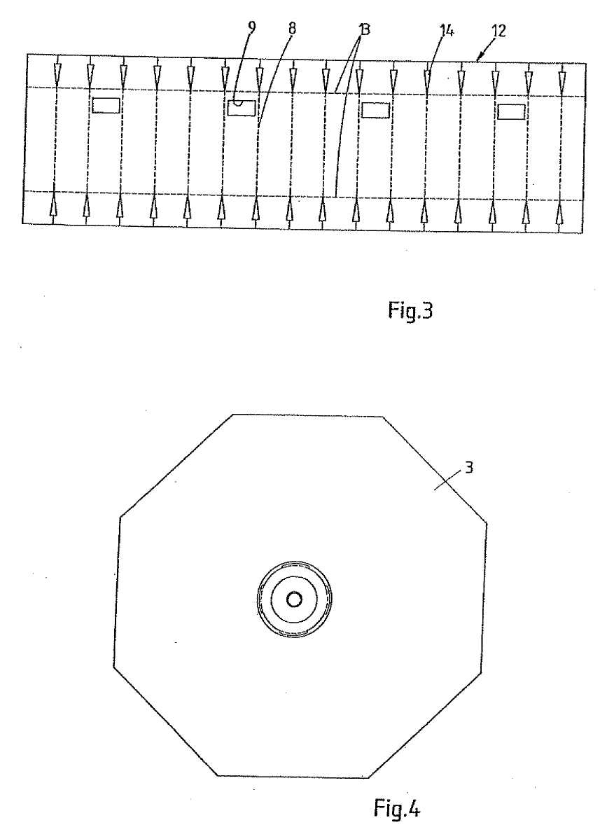

The valve part 4 is connected to the inner casing 3 and in fluid communication with the interior 5 of the inner casing 3. Further, the valve part 4 is screwed into an opening in the top of the outer casing, as will be explained in more detail below. A suitable valve part is disclosed in International patent application WO00/07902, which is incorporated herein by reference in its entirety. (See especially page 8, line 12 ff. in conjunction with FIGS. 4A and 4B). In accordance with a first aspect of the present invention, the container 1, shown in FIG. 2, is provided with an outer package, which follows and abuts the circumference of the outer casing 2 at its maximum diameter. The outer package comprises a substantially cylindrical shell 6, made for example of cardboard, which partially envelops the outer casing 2 and which is open at its top and bottom ends, i.e. the cylindrical shell 6 is co-axial with the central axis of the outer casing.

The shell 6 has a polygonal cross-section with N, e.g. twelve, sixteen or twenty, angles and N, for example, substantially flat panels 7 connected via fold lines 8. A plurality of rectangular openings 9, e.g. four equidistant openings, is provided in the shell 6 to serve as grips. Further, resilient lamellae 10 are present on the inner wall, or otherwise provided inwardly, of the shell 6 and at or near its top and bottom rims. In this example, the lamellae 10 are extensions of the panels 7 folded inwards, i.e. directed towards the imaginary central axis of the casing, which axis extends through the valve part, and towards an imaginary plane (equator) perpendicular to the said central axis and dividing the outer casing in an upper portion and a lower portion, and provide a very effective one-way retaining means to lock the outer casing 2 inside the shell 6. When a casing 2 enters the top end of the outer packager the upper lamellae 10 are urged, by the lower half of the casing 2, towards the inner wall of the shell 6. When the middle of the casing 2, i.e. its maximum diameter portion, passes the lamellae 10, the lamellae 10 flex inwards thus preventing the casing 2 from being easily removed from the shell 6. The lower lamellae serve as a stop. As soon as the casing 2 reaches these lower lamellae the casing 2 is locked in place.

Optionally, a strip 11 (FIG. 2B) of a reinforcing material, for instance cardboard, is attached to the inner wall of the shell 6 in between the upper rim and the grips.

The outer package significantly improves handling and provides effective protection of the spherical or spheroid casing with a relatively small amount of material, especially when compared to a box. Further, the package allows the container to be stored and stacked in an upright position and one on top of the other, thus utilizing the load-bearing capabilities of the present container in its upright position. The equidistant grips also facilitate handing the container from one person to the next, for instance while loading a vehicle or vessel.

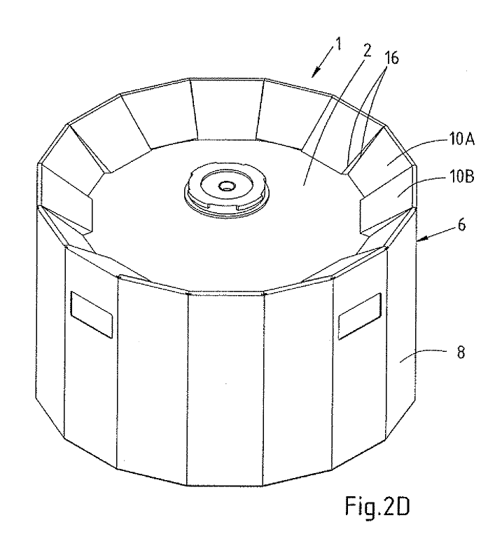

FIG. 3 shows a blank 12 (e.g. cardboard) for folding the shell 6. The blank 12 is substantially oblong in shape and comprises two (relatively long) fold lines 13, extending parallel to the long sides of the blank, and a plurality of fold lines 8, extending parallel to the short sides of the blank 12. It further comprises, at a distance in a range from 1 to 4 cm from both of its long sides and on the fold lines 8, a plurality of outwardly divergent, e.g. triangular, slots 14, preferably extending up to the (relatively long) fold lines 13.

The blank 12 is formed into a shell 6 by gluing the short ends of the blank 12 together and pressing the lamellae 10 trough the open top and bottom ends. Subsequently, an outer casing can be pushed through the top end of the shell 5, as set out above.

To prevent water from reaching the shell, the outer package in turn can be wrapped in a water-impermeable shrink film 15 (FIG. 2C). In one embodiment, that printing, such as a trademark of the fluid in the container or decorations e.g. the outlines and colors of a metal keg, is applied to the film.

In a another embodiment (FIG. 2D), the cardboard blank comprises, instead of the triangular slots (14), further fold lines 16, which are V-shaped, have an apex in excess of 20°, e.g. 30°, and converge from one of the long sides of the blank (12) up to a corresponding (relatively long) fold line 13. In a shell 6 folded from such a blank, the lamellae 10 are still interconnected and, in consequence, forced inwards and outwards alternately. As a result, the lamellae 10A, 10B extend at different angles with respect to the rim, where the difference between the angles is, in one embodiment, greater than or equal to approximately 10°. In one embodiment, the lamellae 10A, 10B can extend alternately at these different angles with respect to the rim. In a further embodiment one of the angles for the lamellae 10A can be relatively small (e.g approximately 30° or less), while the other angle for the lamellae 10B is relatively large (e.g. approximately 60° or greater).

This arrangement provides an effective and stable lock of the outer casing 2 inside the shell 6. Further, this arrangement enhances stackability in that the lamellae 10 more effectively transmit forces from the shell to the (pressurized) outer casing and from the outer casing to the shell. The casing, which is typically pressurized at least during storage, thus contributes to the strength, in particular the bearing capacity, of the container as a whole (casing plus shell).

FIG. 4 is a top plan view of an empty, that is to say flat, inner casing 3. In accordance with an embodiment of this aspect of the present invention, this casing 3 comprises two polygonal, in this example octagonal, flexible sheets 15 of a gas and liquid tight laminate, such as a laminate comprising a sealing layer (e.g. PP), a barrier layer (e.g. aluminum) and one or more further layers (e.g. PA (polyamide) and/or PET (polyethylene terephthalate)), sealed together along their edges, e.g. by means of welding. As a matter of course, one of the sheets is provided with a valve part 4. The inner casing 3 is robust, corresponds, in its fully expanded condition, in shape to the inner wall of the outer casing and can be obtained in a relatively straightforward manner. Furthermore, due to the fact that, in its fully deflated condition, the inner casing is flat, it allows relatively easy folding to a size and shape that facilitate entering the inner casing into the outer casing.

In accordance with a further aspect of the present invention, the outer casing is obtained by melting a polymeric material, forming the casing, and a threaded opening in its wall, from the melted material by means of blow-molding, and screwing the valve part into the opening the casing before it has cooled down to a temperature below 50° C. Thus, a tight fit between the valve part and the casing is obtained and milling of the upper rim of the opening, to improve the fluid-tightness of the connection, is no longer required.

Although the subject matter has been described in language specific to structural features and/or methodological acts, it is to be understood that the subject matter defined in the appended claims is not limited to the specific features or acts described above as has been held by the courts. Rather, the specific features and acts described above are disclosed as example forms of implementing the claims. For instance, the shell can be made of more durable material, such as a plastic and/or metal, such as aluminium, sheet material. Also, although the container described above typically has a capacity of 30 litres, smaller versions, preferably weighing less that 25 kilograms (when filled), are useful in reducing the strain on those who have to handle the containers. As the (empty) containers typically weigh less than 1.5 kilograms, a container having a maximum total weight of 25 kilogram would still have a capacity of 23.5 kilograms (˜litres) of liquid. In comparison, an empty metal keg having a capacity of 23.5 kilograms of liquid would weigh at least 8 kilograms, yielding a total of at least 31.5 kilograms. The container is also suitable for holding pressurised gasses, for instance medical gasses or industrial gasses, such as LPG, natural gas, or hydrogen.

Although the subject matter has been described in language directed to specific environments, structural features and/or methodological acts, it is to be understood that the subject matter defined in the appended claims is not limited to the environments, specific features or acts described above as has been held by the courts. Rather, the environments, specific features and acts described above are disclosed as example forms of implementing the claims. In addition, workers skilled in the art will recognize that changes may be made in form and detail without departing from the spirit and scope of the inventive concepts described herein.

What is claimed is:

1. A container for fluids comprising a spherical or spheroid casing, a valve part for filling the container with a fluid and an outer package surrounding the casing, wherein the outer package comprises a shell, which follows the circumference of the casing.

2. The container according to claim 1, wherein the shell is cylindrical and has a circular cross-section or a polygonal cross-section with at least five angles.

3. The container according to claim 2, wherein at least one of the ends of the cylindrical shell is open and the valve part is accessible through this open end.

4. The container according to claim 1, wherein the shell comprises a plurality of grips, such that, when the container is lifted by means of these grips, the valve part will face upwards.

5. The container according to claim 1, wherein the shell comprises, on its inner wall and at or near its rim nearest the valve part and/or at or near its rim remote from the valve part, means for retaining the casing inside the shell.

6. The container according to claim 5, comprising a plurality of inwardly extending lamellae providing a one way retaining means.

7. The container according to claim 6, wherein the lamellae extend at different angles with respect to the rim.

8. The container according to claim 7, wherein the lamellae extend alternately at different angles with respect to the rim.

9. The container according to claim 7, wherein the lamellae extend alternately at a relatively small and a relatively large angle, with respect to the rim.

10. The container according to claim 1 and further comprising a water-impermeable film covering the shell.

11. A container for fluids comprising a spherical or spheroid casing, a valve part for filling the container with a fluid and an outer package surrounding the casing, wherein the outer package comprises a shell, which follows the circumference of the casing and which is cylindrical and has a circular cross-section or a polygonal cross-section with at least five angles, the shell further comprising, on its inner wall and at or near its rim nearest the valve part and/or at or near its rim remote from the valve part, a plurality of lamellae extending inwardly towards the imaginary central axis of the casing, which axis extends through the valve part, and towards an imaginary plane (equator) perpendicular to the said central axis and dividing the outer casing in an upper portion and a lower portion, and providing a one way retaining mechanism.

12. A blank for folding an outer package around a spherical or spheroid casing, which blank is substantially oblong in shape and which comprises a plurality of fold lines, extending substantially parallel to the short sides of the blank, and, at or near at least one of the long sides and on the fold lines, a plurality of cuts, slots or further fold lines.

13. The blank according to claim 12, wherein the further fold lines are V-shaped and have an apex in excess of 20°.

14. A container for fluids comprising an outer casing, a gas and/or fluid tight inner casing of a flexible material located inside the outer casing, and a valve part for filling the container with a fluid, wherein the inner casing comprises at least one polygonal sheet of a flexible material.

15. The container according to claim 14, wherein the inner casing comprises two polygonal sheets of a flexible material sealed together along their edges.

16. The container according to claim 14, wherein the volume taken up by the inner casing, in fully expanded condition, exceeds the volume enclosed by the inner wall of the outer casing.

17. The container according to claim 14, wherein the outer casing comprises a blow-molded polymeric liner provided with a filament wound reinforcement and an outer layer of latex.

18. A method of making a container for fluids, comprising a casing having an opening and a valve part attached to the opening, the method comprising:
melting a polymeric material,
forming the casing from the material, and
attaching the valve part to the casing while the casing is still sufficiently hot for it to be plastically deformed.

19. The method according to claim 18, wherein the valve part is still sufficiently hot or, in the alternative, heated to a temperature sufficiently high for it to be plastically deformed.

20. The method according to claim 18, wherein the valve part comprises a threaded portion or a snap-fit element, the casing is formed in a mold comprising a feature corresponding to that threaded portion or snap-fit element, such that the molded casing comprises a threaded opening or an opening comprising a snap-fit counter element for receiving the threaded portion or the snap-fit element of the valve part, and wherein the valve part is screwed to respectively snap-fitted onto the inner casing.
